(19) United States
(12) Patent Application Publication
(10) Pub. No.: US 2009/0048960 A1
(43) Pub. Date: Feb. 19, 2009

(54) BIPARTITE MATCHING MARKET FOR UTILIZATION WITH ADVERTISEMENT PLACEMENT EXCHANGE SYSTEM

(75) Inventor: Rahul Jain, Elmsford, NY (US)

Correspondence Address: CANTOR COLBURN LLP-IBM YORKTOWN, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/837,616

(22) Filed: Aug. 13, 2007

(51) Int. Cl. G06Q 40/00

(52) U.S. Cl. 705/37

(57) ABSTRACT

Exemplary embodiments of the present invention relate to a bipartite matching exchange methodology. The method comprising receiving at least one buy bid from at least one buying party, receiving at least one sell bid from at least one selling party, and matching the at least one sell bid with the at least one buy bid thereby yielding at least one matched buy bid and at least one matched sell bid wherein the resulting allocation of the at least one matched buy bid and the at least one matched sell bid maximize a surplus of an exchange.

### BACKGROUND OF THE INVENTION

1. Field of the Invention

This invention relates to the field of bipartite matching algorithms, and particularly to the field of market-based bipartite auction matching algorithms.

2. Description of Background

Current methods for the place advertisements on third-party websites primarily consist of matching an advertiser with a third-party website, and subsequently displaying the advertiser's ad at the third-party's website. As implemented, advertisers submit bids on keywords, and based upon relevance and the bids, the advertiser's ad will be placed on the website of participating hosts. Typically, advertisers pay every time their ad is clicked according to predetermined payment rules, while a host will receive a share of the payment received from the advertiser. Currently, a double-sided market mechanism where both advertisers bid on keywords as well as the hosts does not exist.

### SUMMARY OF THE INVENTION

The shortcomings of the prior art are overcome and additional advantages are provided through the provision of a bipartite matching exchange method. The method comprising receiving at least one buy bid from at least one buying party, receiving at least one sell bid from at least one selling party, and matching the at least one sell bid with the at least one buy bid thereby yielding at least one matched buy bid and at least one matched sell bid wherein the resulting allocation of the at least one matched buy bid and the at least one matched sell bid maximize a surplus of an exchange, the surplus of the exchange being defined as

$${\sum }_{ij} ( {β}_{ij} {b}_{ij} - {α}_{ij} {a}_{ij} ) {x}_{ij} .$$

Computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of a bipartite matching exchange system in accordance with exemplary embodiments of the present invention.

FIG. 2 illustrates one example of a flow diagram detailing aspects of a bipartite matching exchange method in accordance with exemplary embodiments of the present invention.

The detailed description explains the preferred embodiments of the invention, together with advantages and features, by way of example with reference to the drawings.

### DETAILED DESCRIPTION OF THE INVENTION

One or more exemplary embodiments of the invention are described below in detail. The disclosed embodiments are intended to be illustrative only since numerous modifications and variations therein will be apparent to those of ordinary skill in the art.

Exemplary embodiments of the present invention comprise a bipartite auction-based matching methodology wherein buyers make bids specifying a bid for each seller in which a buyer is interested. Similarly, sellers specify a reserve price-bid for each buyer with whom they are interested in matching. The difference between a buyer's bid for a seller and a seller's bid for that buyer is referred to as a matching surplus. Within the exemplary embodiments the methodology utilizes these bids to determine an assignment or matching that maximizes a revealed matching surplus. A set of payments determined using a formula that is based upon the gathered bids. Lastly, the buyer makes the corresponding payment to the seller with whom it has been matched.

Aspects of the present invention are carried out within a computing system environment. The computer system as operated by a system user can embody a conventional personal computer system on which an application that is configured to accomplish the objectives of the present methodologies is operating. As is conventional, the computer system also includes other hardware and software elements that are conventionally included in personal computer systems.

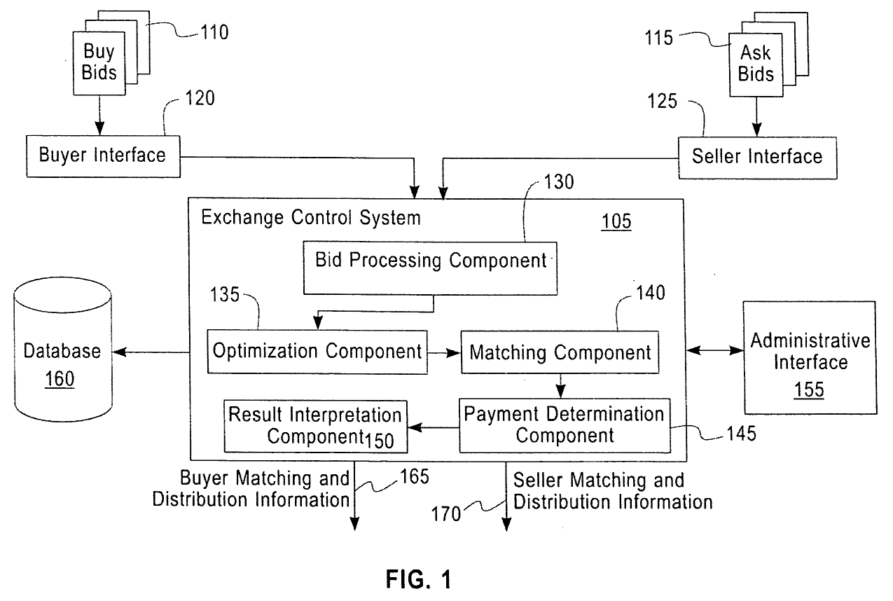

Turning now to the drawings in greater detail, it will be seen that in FIG. 1 there is an exemplary bipartite matching exchange system. As shown in FIG. 1, a plurality of bids from a buyer or buyers 110 is received at an exchange control system 105 via a buyer interface 120. Similarly, a plurality of bids from a seller or sellers 115 is received at the exchange control system 105 via a seller interface 125. The buyer 120 and seller 125 interfaces can comprise GUIs that are display at display devices at respective networked computing systems situated at each buyer or seller's location.

The exchange control system 105 comprises a processor (not shown) in addition to a main memory (not shown) that is in communication with the processor. An administrator interface 155 is provided in order to receive input and output information to a system administrator who may monitor all bid processing activities. The exchange control system 105 further comprises a series of software components that are implemented to carry out the objectives of the exemplary embodiments of the present invention. The software components further comprising a bid processing component 130, a bid optimization component 135, a bid-matching component 140, a payment determination component 145, and a result interpretation component 150. The software components may reside in the main memory or may reside in other areas of the exchange control system 105.

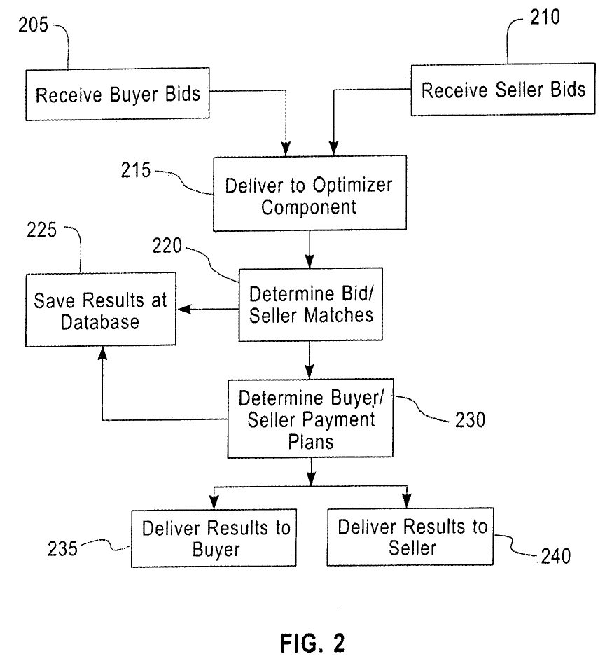

In reference to FIGS. 1 and 2, bids are elicited from both the buyers (step 205) and sellers (step 210) and delivered to the bid processing component 130. Within the exemplary embodiments of the present invention received bids are considered to be indicative of true valuations and costs for a respective item or service. Next, the bids 105, 110 are delivered to bid optimizer component 135 (step 215). The function of the bid optimizing component being to match the buyer bids to the seller bids wherein the resulting allocation of at least one matched buy bid and at least one matched sell bid maximize a surplus of an exchange. The bid optimization component is implemented to match potential buyers with potential sellers by solving the equation

$${\sum }_{ij} ( {β}_{ij} {b}_{ij} - {α}_{ij} {a}_{ij} ) {x}_{ij}$$

within exemplary embodiments of the present invention; wherein i is representative of a buyer and j is representative of a seller. A buyer i bids bᵢⱼ for seller j's slot and seller j places a minimum reservation price bid aⱼ. βᵢⱼ serves as a weight coefficient for bid bᵢⱼ and αᵢⱼ as a weight coefficient for bid aᵢⱼ. Further, xᵢⱼ is any real number 0≦xᵢⱼ≦1 representing the probability of buyer i and seller j being matched, i being an integer index where 0≦i≦M where M is a number of buyers participating in the exchange. Yet further bᵢⱼ represents a buy bid of a buyer i for a seller j, j being an integer index where 0≦j≦N, wherein N represents a number of sellers participating in the exchange and αᵢⱼ is an ask bid of the j^{th} seller for buyer i.

The results from the bid optimization component 135 are delivered to the bid-matching component 140 for further processing. Once the potential buyers have been matched with the potential sellers (step 220) the determined buyer/seller match information is stored at a database 160 (step 225) and delivered to the payment determination component 150 (step 230) wherein the allotted payments for a respective buyer to make to a respective seller will be determined by determining the surplus of exchange for a specific transaction between a buyer and seller.

The surplus of the exchange being defined as ρᵢⱼ=(βᵢⱼbᵢⱼ−αᵢⱼαᵢⱼ), wherein respective buyers and sellers are matched and sequentially ranked according to pairings from the highest to the lowest resultant for ρᵢⱼ≧0. A payment by buyer i is denoted by μi and a payment to seller j is denoted λj. A payment function is considered to be strongly budget-balanced in the event that a buyer i is matched with seller j, and their absolute payments are equal. Further, if a buyer i is matched with a seller j (i.e., xᵢⱼ>0), then the matching price pᵢⱼ is defined according to as aᵢⱼ′=bᵢⱼ−max_{k>i}ρᵢₖ⁺ and bᵢⱼ′=aᵢⱼ+max(max_{k>i} ρₖᵢ⁺, max_{k>i}ρᵢₖ⁺) as ρᵢⱼ=αaᵢⱼ′+(1−α)bᵢⱼ′ for some α between 0 and 1, wherein k is the number of matches after solving the bid optimization problem

$${\sum }_{ij} ( {β}_{ij} {b}_{ij} - {α}_{ij} {a}_{ij} ) {x}_{ij} .$$

Payment information is determined respectively for a matched buyer and a matched seller. Within further exemplary embodiments of the present invention a buyer may have an account that is maintained by the exchange control system 105, wherein the buyer independently funds the account. In the instance that a buyer has an account with the exchange control system, then the determined payments for a buyer can be automatically deducted from the account once the payment schedule has been generated at the result interpretation component 145. The buyer/seller payment information that has been generated by the result interpretation component 145 is stored at the database 160 and the payment schedule determinations are delivered to the respective buyer/seller pairings (steps 235 and 240).

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A bipartite matching exchange method, the method comprising:
receiving at least one buy bid from at least one buying party;
receiving at least one sell bid from at least one selling party;
matching the at least one sell bid with the at least one buy bid thereby yielding at least one matched buy bid and at least one matched sell bid wherein the resulting allocation of the at least one matched buy bid and the at least one matched sell bid maximize a surplus of an exchange, the surplus of the exchange being defined
$${\sum }_{ij} ( {β}_{ij} {b}_{ij} - {α}_{ij} {a}_{ij} ) {x}_{ij} .$$

2. The method of claim 1, wherein the exchange is constrained so that each buyer is matched with only one seller.

3. The method of claim 1, wherein if a buyer i is matched with a seller j then the matching price pᵢⱼ is defined according to aᵢⱼ′=bᵢⱼ−max_{k>i}ρᵢⱼ⁺ and bᵢⱼ′=aᵢⱼ+max(max_{k>i}ρₖᵢ⁺, max_{k>i}ρᵢₖ⁺) as ρᵢⱼ=αaᵢⱼ′+(1−α)bᵢⱼ′ for some a between 0 and 1.

4. A computer program product that includes a computer readable medium useable by a processor, the medium having stored thereon a sequence of instructions which, when executed by the processor, causes the processor to implement a bipartite matching exchange by:
receiving at least one buy bid from at least one buying party;
receiving at least one sell bid from at least one selling party;
matching the at least one sell bid with the at least one buy bid thereby yielding at least one matched buy bid and at least one matched sell bid wherein the resulting allocation of the at least one matched buy bid and the at least one matched sell bid maximize a surplus of an exchange, the surplus of the exchange being defined as
$${\sum }_{ij} ( {β}_{ij} {b}_{ij} - {α}_{ij} {a}_{ij} ) {x}_{ij} .$$

5. The computer program product of claim 4, wherein the exchange is constrained so that each buyer is matched with only one seller.

6. The computer program product of claim 4, wherein in a buyer i is matched with a seller j then the matching price pᵢⱼ is defined according to aᵢⱼ′=bᵢⱼ−max_{k>1}ρᵢₖ⁺ and bᵢⱼ′=aᵢⱼ+max(max_{k>i}ρₖᵢ⁺, max_{k>i}ρᵢₖ⁺) as ρᵢⱼ=αaᵢⱼ′+(1−α)bᵢⱼ′ for some α between 0 and 1.
